(19) United States
(12) Patent Application Publication
(10) Pub. No.: US 2026/0029288 A1
(43) Pub. Date: Jan. 29, 2026

(54) PRESSURE TRANSDUCER AND PREPARATION METHOD THEREOF, AND DETECTION DEVICE

(71) Applicants: BEIJING BOE SENSOR TECHNOLOGY CO., LTD., Beijing (CN); BOE TECHNOLOGY GROUP CO., LTD., Beijing (CN); BEIJING BOE TECHNOLOGY DEVELOPMENT CO., LTD., Beijing (CN)

(72) Inventors: Lihui Wang, Beijing (CN); Yue Li, Beijing (CN); Qiuxu Wei, Beijing (CN); Weilong Guo, Beijing (CN); Wenbo Chang, Beijing (CN); Taonan Zhang, Beijing (CN); Jie Sun, Beijing (CN); Nana He, Beijing (CN); Feng Qu, Beijing (CN)

(73) Assignees: BEIJING BOE SENSOR TECHNOLOGY CO., LTD., Beijing (CN); BOE TECHNOLOGY GROUP CO., LTD., Beijing (CN); BEIJING BOE TECHNOLOGY DEVELOPMENT CO., LTD., Beijing (CN)

(21) Appl. No.: 18/995,395

(22) PCT Filed: May 23, 2024
(86) PCT No.: PCT/CN2024/094954

§ 371 Date: Jan. 16, 2025

(30) Foreign Application Priority Data
May 26, 2023 (CN) 202310611959.8

(51) Int. Cl. G01L 9/00; G01L 19/00

(52) U.S. Cl. CPC G01L 9/0075; G01L 19/0061

(57) ABSTRACT

A pressure transducer and a preparation method thereof, and a detection device are disclosed, which relate to the technical field of pressure transducers. The pressure transducer includes: a first substrate; a second substrate including a pressure sensitive film, a sealed pressure reference chamber being provided between the pressure sensitive film and the first substrate, the pressure sensitive film being capable to be deformed in a direction towards or away from the first substrate, and the second substrate being a glass substrate; a first polar plate, a part or all area of the first polar plate is arranged on the pressure sensitive film; and a second polar plate arranged on a side of the first substrate facing the pressure sensitive film, and a part or all area of the second polar plate being directly opposite to the first polar plate to form a capacitor with the first polar plate.

### CROSS-REFERENCES TO RELATED APPLICATIONS

This application claims priority to the Chinese patent application filed on May 26, 2023 before the CNIPA, China National Intellectual Property Administration with the application number of 202310611959.8, and the title of “PRESSURE TRANSDUCER AND PREPARATION METHOD THEREOF, AND DETECTION DEVICE”, which is incorporated herein by reference in its entirety.

### TECHNICAL FIELD

The present disclosure relates to the technical field of pressure transducers, in particular to a pressure transducer and a preparation method thereof, and a detection device.

### BACKGROUND

A capacitive pressure transducer has characteristics of high sensitivity and low power consumption, and is widely used in consumer electronics and other fields.

### SUMMARY

Embodiments of the present disclosure provide a pressure transducer and a preparation method thereof, and a detection device.

In order to achieve above objects, embodiments of the present disclosure adopts following technical solutions.

In an aspect, a pressure transducer is provided, including:
a first substrate;
a second substrate including a pressure sensitive film, wherein a sealed pressure reference chamber is arranged between the pressure sensitive film and the first substrate, the pressure sensitive film is capable to be deformed in a direction towards or away from the first substrate, and the second substrate is a glass substrate;
a first polar plate, wherein a part or all area of the first polar plate is arranged on the pressure sensitive film; and
a second polar plate arranged on a side of the first substrate facing the pressure sensitive film, wherein a part or all area of the second polar plate is directly opposite to the first polar plate to form a capacitor with the first polar plate.

In some embodiments, an isolation plate is provided between the first substrate and the second substrate, and an area on the isolation plate opposite to the pressure sensitive film is hollowed out, so that the first substrate, the second substrate and the isolation plate enclose the pressure reference chamber in a hollowed-out area.

In some embodiments, a first sealing ring surrounding the pressure reference chamber is provided between the isolation plate and the first substrate; and/or,
a second sealing ring surrounding the pressure reference chamber is provided between the isolation plate and the second substrate.

In some embodiments, the first sealing ring and/or the second sealing ring are metal rings.

In some embodiments, a first metal layer is provided between the first substrate and the isolation plate, and the first metal layer includes the second polar plate and the first sealing ring; and/or,
a second metal layer is provided between the second substrate and the isolation plate, and the second metal layer includes the first polar plate and the second sealing ring.

In some embodiments, the first metal layer further includes a first lead-out member located between the first substrate and the isolation plate, and the second polar plate is electrically connected to the first lead-out member; and/or,
the second metal layer further includes a second lead-out member located between the second substrate and the isolation plate, and the first polar plate is electrically connected to the second lead-out member.

In some embodiments, orthogonal projections of the first lead-out member and the second lead-out member on the first substrate do not overlap with each other.

In some embodiments, the first metal layer further includes an adapter located between the isolation plate and the first substrate, the adapter is electrically connected to the second lead-out member through a via, and the adapter is disconnected from the second polar plate.

In some embodiments, a first conductive pillar and a second conductive pillar are provided in the first substrate, the first conductive pillar and the second conductive pillar penetrate through the first substrate in a direction perpendicular to the first substrate, an end of the first conductive pillar facing the second substrate is electrically connected to the adapter, and an end of the second conductive pillar facing the second substrate is electrically connected to the first lead-out member.

In some embodiments, the first substrate includes a groove arranged opposite to the pressure sensitive film and a connecting part surrounding the groove, and the connecting part is connected to the second substrate.

In some embodiments, a third metal layer is provided between the first substrate and the second substrate, and the third metal layer includes the first polar plate and a third sealing ring, and the first substrate and the second substrate are sealingly connected to each other through the third sealing ring.

In some embodiments, the third metal layer further includes a third lead-out member located between an edge area of the first substrate and an edge area of the second substrate, and the third lead-out member is electrically connected to the first polar plate; and

a fourth conductive pillar and a fifth conductive pillar are provided in the first substrate, the fourth conductive pillar and the fifth conductive pillar penetrate through the first substrate along a direction perpendicular to the first substrate, an end of the fourth conductive pillar facing the second substrate is electrically connected to the third lead-out member, and an end of the fifth conductive pillar facing the second substrate is electrically connected to the second polar plate.

In some embodiments, the first substrate is the glass substrate.

In some embodiments, the isolation plate is the glass substrate.

In some embodiments, a side of the first substrate away from the second substrate is provided with a connector, the connector is electrically connected to the first plate or the second plate, and the connector is configured to be electrically connected to an external detection circuit; and
the connector includes a redistribution layer, an under bump metallization layer and solder which are sequentially arranged along a direction away from the first substrate.

In some embodiments, the second substrate and the first substrate are oppositely arranged, and the second substrate includes a middle area in the middle and an edge area surrounding the middle area, the edge area of the second substrate is sealingly connected to the first substrate, so that the middle area of the second substrate and the first substrate enclose a sealed pressure reference chamber, and the pressure sensitive film is located in the middle area of the second substrate.

In some embodiments, a second groove is provided on a side of the middle area of the second substrate facing the first substrate, and the second groove and the first substrate enclose the pressure reference chamber.

In some embodiments, a first groove is provided in an area of the first substrate opposite to the middle area, and the first groove and the second substrate enclose the pressure reference chamber.

In some embodiments, a first groove is provided in an area of the first substrate opposite to the middle area, and a second groove is provided on a side of the middle area of the second substrate facing the first substrate, and the first groove and the second groove are buckled to form the pressure reference chamber.

In another aspect, a preparation method of a pressure transducer is provided, including:
providing a first film layer, wherein the first film layer includes a first substrate and a second polar plate arranged on the first substrate;
providing a second film layer, wherein the second film layer includes a second substrate and a first polar plate arranged on the second substrate, the second substrate includes a pressure sensitive film, a part or all area of the first polar plate is arranged on the pressure sensitive film, and the second substrate is a glass substrate; and
connecting the first film layer to the second film layer, wherein after the first film layer and the second film layer are connected to each other, a sealed pressure reference chamber is formed between the pressure sensitive film and the first substrate, and a part or all area of the second polar plate is directly opposite to the first polar plate to form a capacitor with the first polar plate.

In some embodiments, the connecting the first film layer to the second film layer includes:
forming an isolation plate on the first film layer, wherein the isolation plate is provided with a hollowed-out area; and
connecting the second film layer on a side of the isolation plate away from the first film layer, wherein the pressure sensitive film, the isolation plate and the first substrate enclose the pressure reference chamber in the hollowed-out area.

In some embodiments, the first substrate includes a groove and a connecting part surrounding the groove, and the connecting the first film layer to the second film layer includes:
sealingly connecting the second substrate to the connecting part of the first substrate, wherein after the second substrate is connected to the first substrate, the pressure sensitive film and the groove enclose the pressure reference chamber.

In yet another aspect, a detection device is provided, including a control panel and the pressure transducer, wherein a detection circuit is provided on the control panel, and the pressure transducer is electrically connected to the detection circuit.

The above description is only an overview of the technical solution of the present disclosure In order to have a clearer understanding of the technical means of the present disclosure, it can be implemented according to the content of the specification. In order to make the above and other purposes, features, and advantages of the present disclosure more obvious and understandable, the specific embodiments of the present disclosure are listed below.

### BRIEF DESCRIPTION OF THE DRAWINGS

In order to provide a clearer explanation of the technical solutions in the embodiments of the present disclosure or in the related art, a brief introduction will be given to the accompanying drawings required for the description of the embodiments or related art. It is obvious that the accompanying drawings in the following description are some embodiments of the present disclosure. For those skilled in the art, other drawings can be obtained based on these drawings without creative work.

FIG. 1 schematically shows a top view of a pressure transducer;

FIG. 2 is a cross-sectional view taken along A-A in FIG. 1;

FIG. 3 is an exploded view of the pressure transducer shown in FIG. 2;

FIG. 4 to FIG. 18 schematically show a process flow chart of a pressure transducer;

FIG. 19 is another cross-sectional view taken along A-A in FIG. 1;

FIG. 20 is an exploded view of the pressure transducer shown in FIG. 19;

FIG. 21 to FIG. 27 schematically show a process flow chart of another pressure transducer; and

FIG. 28 schematically shows a flow chart of a preparation method of a pressure transducer.

### DETAILED DESCRIPTION

In order to clarify the purpose, technical solution, and advantages of the embodiments of the present disclosure, a clear and complete description of the technical solution in the embodiments of the present disclosure will be provided below in conjunction with the accompanying drawings. Obviously, the described embodiments are a part of the embodiments of the present disclosure, not all of the embodiments. Based on the embodiments of the present disclosure, all other embodiments obtained by persons skilled in the art without creative work are within the scope of protection of the present disclosure.

A clear and complete description of the technical solution in the embodiments of the present disclosure will be provided below in conjunction with the accompanying drawings. Obviously, the described embodiments are a part of the embodiments of the present disclosure, not all of the embodiments. Based on the embodiments of the present disclosure, all other embodiments obtained by persons skilled in the art without creative work are within the scope of protection of the present disclosure.

In the embodiments of the present disclosure, the use of words such as “first”, “second”, “third”, “fourth” to distinguish similar or identical items with similar functions and effects is only for the purpose of clearly describing the technical solution of the embodiments of the present disclosure, and cannot be understood as indicating or implying relative importance or implying the number of technical features indicated.

In the embodiments of the present disclosure, the meaning of “plurality of” refers to two or more, and the meaning of “at least one” refers to one or more, unless otherwise specified.

In the embodiments of the present disclosure herein, the terms “up”, “down”, etc. indicate orientation or positional relationships based on the orientation or positional relationships shown in the accompanying drawings. This is only for the convenience of describing and simplifying the description of the present disclosure, and does not indicate or imply that the device or element referred to must have a specific orientation, be constructed and operated in a specific orientation, and therefore cannot be understood as a limitation of the present disclosure.

A pressure transducer is a device that can receive pressure information and convert it into an electrical signal according to certain rules. Pressure transducers can be divided into four main types: piezoresistive pressure transducers, capacitive pressure transducers, resonant pressure transducers and piezoelectric pressure transducers. The capacitive pressure transducer has characteristics of high sensitivity and low power consumption, and is widely used in consumer electronics and other fields.

In related art, the capacitive pressure transducer usually includes a lower substrate and an upper substrate which are arranged oppositely and at intervals. The lower substrate and the upper substrate jointly enclose a sealed chamber, and a lower polar plate located on the lower substrate and an upper polar plate located on the upper substrate are arranged in the sealed chamber, and the upper polar plate and the lower polar plate are oppositely arranged to form a parallel-plate capacitor. When pressures inside and outside the sealed chamber are different, the upper substrate is deformed under action of pressure difference, which drives the upper polar plate to move and changes a gap between the upper polar plate and the lower polar plate, so that a capacitance value of the capacitor changes, that is, an electrical signal output by the capacitive pressure transducer changes. Because the pressure outside the sealed chamber is in a functional relationship with the gap, and the gap is in a functional relationship with the electrical signal output by the capacitive pressure transducer, the pressure outside the sealed chamber can be calculated according to the electrical signal output by the capacitive pressure transducer.

According to materials of the upper and lower substrates of the capacitive pressure transducer, the capacitive pressure transducer includes a silicon-based capacitive pressure transducer and a ceramic-based capacitive pressure transducer.

Firstly, the silicon-based capacitive pressure transducer is illustrated. The upper substrate and the lower substrate of the silicon-based capacitive pressure transducer are both made of a silicon material, and thus Micro-Electro-Mechanical System (MEMS) technology can be adopted in preparing the silicon-based capacitive pressure transducer. However, the silicon-based capacitive pressure transducer has following two disadvantages.

a. Silicon is a semiconductor material, and a concentration of carriers in the upper and lower substrates is high, which results in high dielectric loss and much noise of the silicon-based capacitive pressure transducer.

b. A case where the upper substrate is a square substrate and the sealed chamber is a vacuum chamber is taken as an example. When the upper substrate is subjected to the pressure outside the sealed chamber, a calculation formula for maximum deformation of the upper substrate is shown in a following formula (1):

$$ω = 0.01518 \frac{{Pl}^{4} ( 1 - {μ}^{2} )}{{Eh}^{3}} \qquad ( 1 )$$

In the calculation formula, w is the maximum deformation of the upper substrate, P is the pressure outside the sealed chamber, u is a Poisson's ratio of a material of the upper substrate, E is an elastic modulus of the material of the upper substrate, l is a side length of the upper substrate, and h is a thickness of the upper substrate.

In order to improve linearity between the electrical signal output by the capacitive pressure transducer and the pressure outside the sealed chamber, the maximum deformation of the upper substrate should conform to a small deflection theory, that is, the maximum deformation of the upper substrate should be less than a maximum value. In order to improve sensitivity of the capacitive pressure transducer, the maximum deformation of the upper substrate needs to be greater than a minimum value. Therefore, the maximum deformation of the upper substrate in the capacitive pressure transducer needs to be between the minimum value and the maximum value.

It can be seen from formula (1) that the maximum deformation of the upper substrate is inversely proportional to cubic of the thickness of the upper substrate. After the side length l of the upper substrate is determined (determined according to a size of the capacitive pressure transducer in practical applications) and the elastic modulus and Poisson's ratio of the upper substrate are determined (after the material of the upper substrate is determined, the elastic modulus and Poisson's ratio are determined), it is necessary to adjust the maximum deformation of the upper substrate by adjusting the thickness of the upper substrate, so that the maximum deformation of the upper substrate is greater than the minimum value and less than the maximum value. Because an elastic modulus of the silicon material is large (about 170 GPa) and its Poisson's ratio is large (about 0.278), the thickness of the upper substrate needs to be set small (for example, the thickness of the upper substrate of the capacitive pressure transducer with a range of 120 kPa in practical application is less than 1 μm), which results in easy breakage of the upper substrate in preparing the silicon-based capacitive pressure transducer, with a high defect rate. Moreover, thickness consistency of the upper substrates in different silicon-based capacitive pressure transducers is also poor.

In the following, the ceramic-based capacitive pressure transducer is illustrated. The upper and lower substrates of the ceramic-based capacitive pressure transducer are made of a ceramic material. Compared with the silicon-based capacitive pressure transducer, the ceramic material is an insulating material, and thus the ceramic-based capacitive pressure transducer has lower dielectric loss and less noise. However, due to incompatibility between the ceramic material and the MEMS technology, the ceramic-based capacitive pressure transducer is usually fabricated in a monolithic production mode, which makes a size of the ceramic-based capacitive pressure transducer large and consistency between different ceramic-based capacitive pressure transducers is poor.

In view of this, a pressure transducer is provided in an embodiment of the present disclosure. A substrate of the pressure transducer is made of a glass material, so that a thickness of the substrate can be set to be large, which is compatible with MEMS technology and reduces defect rate in a process of preparing the pressure transducer.

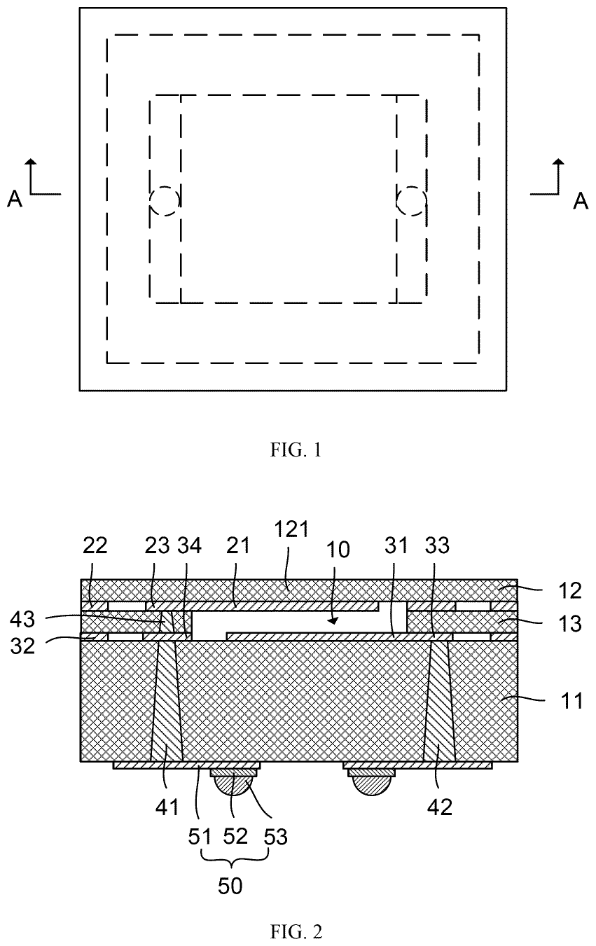

FIG. 1 schematically shows a top view of a pressure transducer, FIG. 2 is a cross-sectional view taken along A-A in FIG. 1, and FIG. 19 is another cross-sectional view taken along A-A in FIG. 1. As shown in FIGS. 1, 2 and 19, the pressure transducer includes a first substrate 11, a second substrate 12, a first polar plate 21 and a second polar plate 31.

With continued reference to FIG. 2 and FIG. 19, the second substrate 12 includes a pressure sensitive film 121. The pressure sensitive film 121 and the first substrate 11 are arranged oppositely and at intervals, and a sealed pressure reference chamber 10 is provided between the pressure sensitive film 121 and the first substrate 11. The pressure sensitive film 121 can be deformed when it is subjected to a pressure, and the pressure reference chamber 10 separates the pressure sensitive film 121 from the first substrate 11 to form a space for deformation of the pressure sensitive film 121. For example, when the pressure sensitive film 121 is subjected to a pressure directed toward the first substrate 11, the pressure sensitive film 121 can be deformed in a direction toward the first substrate 11, and when the pressure sensitive film 121 is subjected to a pressure away from the first substrate 11, the pressure sensitive film 121 can be deformed in a direction away from the first substrate 11.

The pressure reference chamber 10 can be filled with gas or can be a vacuum chamber. If the pressure reference chamber 10 is filled with the gas and the pressure inside the pressure reference chamber 10 is greater than the pressure outside the pressure reference chamber 10, the pressure sensitive film 121 can be deformed in the direction away from the first substrate 11, and when the pressure inside the pressure reference chamber 10 is smaller than the pressure outside the pressure reference chamber 10, the pressure sensitive film 121 can be deformed in the direction toward the first substrate 11. If the pressure reference chamber 10 is the vacuum chamber, the pressure in the pressure reference chamber 10 is always zero, which can prevent ambient temperature from affecting the pressure in the pressure reference chamber 10 and make the pressure transducer more accurate.

Illustratively, the second substrate 12 and the first substrate 11 are arranged opposite to each other. The second substrate 12 includes a middle area in the middle and an edge area surrounding the middle area. The edge area of the second substrate 12 is sealingly connected to the first substrate 11, so that the middle area of the second substrate 12 and the first substrate 11 enclose the sealed pressure reference chamber 10, and the pressure sensitive film 121 is located in the middle area of the second substrate 12.

The pressure reference chamber 10 can be formed in various ways, for example, a groove can be provided on the first substrate 11 and/or the second substrate 12, and the pressure reference chamber 10 is enclosed at the groove.

Illustratively, a side of the middle area of the second substrate 12 facing the first substrate 11 is provided with a second groove, and the second groove and the first substrate 11 enclose the pressure reference chamber 10. The second groove is provided in the middle area of the second substrate 12, which makes a thickness of the middle area small, so that the pressure sensitive film 121 located in the middle area is more easily deformed and the pressure transducer is more sensitive.

Illustratively, as shown in FIG. 19, the first substrate 11 is provided with a first groove in an area opposite to the middle area, and the first groove and the second substrate 12 enclose the pressure reference chamber 10. In practical applications, a thickness of the first substrate 11 is usually greater than a thickness of the second substrate 12, and providing the first groove in the first substrate 11 can prevent the second substrate 12 from being damaged due to reduced strength.

Illustratively, the area of the first substrate 11 opposite to the middle area is provided with the first groove, and a side of the middle area of the second substrate 12 facing the first substrate 11 is provided with the second groove, and the first groove and the second groove are buckled to form the pressure reference chamber 10. When a size of the pressure reference chamber 10 in a direction perpendicular to the first substrate 11 is constant and the first groove and the second groove are provided at the same time, grooving depths of the first groove and the second groove can be reduced, thereby preventing strength of the first substrate 11 and the second substrate 12 from being too low due to grooving.

The first polar plate 21 and the second polar plate 31 are made of a conductive material, and the first polar plate 21 is arranged directly opposite to a part or all area of and the second polar plate 31, so that the first polar plate 21 and the second polar plate 31 form a capacitor.

A part or all area of the first polar plate 21 is arranged on the pressure sensitive film 121. When the pressure sensitive film 121 is deformed, the pressure sensitive film 121 drives the first polar plate 21 to move, changing a gap between the first polar plate 21 and the second polar plate 31, thus changing a capacitance value of the capacitor. For example, when the pressure sensitive film 121 is deformed in the direction toward the first substrate 11, the gap between the first polar plate 21 and the second polar plate 31 becomes smaller, and when the pressure sensitive film 121 is deformed in the direction away from the first substrate 11, the gap between the first polar plate 21 and the second polar plate 31 becomes larger.

The first polar plate 21 may be arranged on a side of the pressure sensitive film 121 facing the first substrate 11 or on a side of the pressure sensitive film 121 away from the first substrate 11. When the first polar plate 21 is arranged on the side of the pressure sensitive film 121 facing the first substrate 11, the first polar plate 21 is located in the sealed pressure reference chamber 10, so that the first polar plate 21 is isolated from particles such as water and oxygen outside, the first polar plate 21 is prevented from being corroded, and the first polar plate 21 can be protected from mechanical damage such as scratches. When the first polar plate 21 is arranged on the side of the pressure sensitive film 121 away from the first substrate 11, the pressure sensitive film 121 is located between the first polar plate 21 and the second polar plate 31, so that short circuiting between the first polar plate 21 and the second polar plate 31 can be prevented.

The second substrate 12 is a glass substrate, that is, the second substrate 12 is made of a glass material, and the pressure sensitive film 121 is also made of the glass material as a part of the second substrate 12. Since an elastic modulus and Poisson's ratio of the glass material are smaller than those of the silicon material, it can be seen from formula (1) that the pressure sensitive film 121 made of the glass material can be thicker than that made of the silicon material in a case of ensuring a same maximum deformation, thus solving problems of easy breakage and high defect rate of the pressure sensitive film due to its small thickness. For example, the elastic modulus of the glass material is 63 GPa and its Poisson's ratio is 0.20, and the elastic modulus of the silicon material is 170 GPa and its Poisson's ratio is 0.278. Under same other conditions, it can be known from formula (1) that the thickness of the pressure sensitive film 121 of the glass material is about 1.5 times that of the silicon material.

Moreover, the MEMS technology is compatible with the glass material, and when the second substrate 12 is the glass substrate, the MEMS technology can be adopted to prepare the pressure transducer. Compared with the monolithic production mode of the ceramic-based capacitive pressure transducer, the pressure transducer according to the embodiment of the present disclosure can be prepared by the MEMES technology, which can improve production efficiency and consistency among different pressure transducers.

In addition, resistivity of the glass material is about 107 Ω·m and resistivity of silicon material is about 103 Ω·m. The resistivity of the glass material is greater than the resistivity of the silicon material, and a number of carriers excited in the second substrate 12 of the glass material is relatively small, which can reduce the dielectric loss and noise of the pressure transducer.

In order to further reduce the dielectric loss and noise of the pressure transducer, the first substrate 11 may also be the glass substrate. Certainly, the first substrate 11 may also be a silicon substrate, which is not limited in the embodiment of the present disclosure.

As shown in FIG. 2 and FIG. 19, the second polar plate 31 is arranged on a side of the first substrate 11 facing the second substrate 12, that is, the second polar plate 31 is located in the sealed pressure reference chamber 10, so that the second polar plate 31 is isolated from particles such as water and oxygen outside, the second polar plate 31 is prevented from being corroded, and the second polar plate 31 can be protected from mechanical damage such as scratches.

The first polar plate 21 can be formed on the second substrate 12 by deposition, and the second polar plate 31 can also be formed on the first substrate 11 by deposition.

Illustratively, an adhesive layer is provided between the first polar plate 21 and the second substrate 12. For example, the first polar plate 21 is made of gold with a thickness of 0.2 μm to 0.5 μm, and the adhesive layer is made of titanium or chromium with a thickness of 20 nm to 50 nm.

Illustratively, an adhesive layer is provided between the second polar plate 31 and the first substrate 11. For example, the second polar plate 31 is made of gold with a thickness of 0.2 μm to 0.5 μm, and the adhesive layer is made of titanium or chromium with a thickness of 20 nm to 50 nm.

The pressure transducer according to the present disclosure will be described in detail in the following in connection with specific examples.

In one embodiment of the present disclosure, as shown in FIG. 2, the pressure transducer includes a first substrate 11, a second substrate 12, and an isolation plate 13 located between the first substrate 11 and the second substrate 12. A part of the isolation plate 13 opposite to the pressure sensitive film 121 is hollowed out, so that the first substrate 11, the second substrate 12 and the isolation plate 13 enclose a pressure reference chamber 10 in the hollowed-out area.

In order to reduce the dielectric loss and noise of the pressure transducer and be compatible with MEMS technology, the isolation plate 13 can be a glass substrate. Certainly, the isolation plate 13 may also be a silicon substrate.

The isolation plate 13 is located between the first substrate 11 and the second substrate 12, and separates the first substrate 11 and the second substrate 12. A thickness of the isolation plate 13 (along a direction perpendicular to the isolation plate 13) directly affects a spacing between the first substrate 11 and the second substrate 12. Since the first polar plate 21 is arranged on the second substrate 12 and the second polar plate 31 is arranged on the first substrate 11, the gap between the first substrate 11 and the second substrate 12 directly affects the gap between the first polar plate 21 and the second polar plate 31. In preparing the pressure transducer, the gap between the first polar plate 21 and the second polar plate 31 can be controlled by controlling the thickness of the isolation plate 13.

In addition, processing accuracy of the isolation plate 13 in a thickness direction is high and size difference between the isolation plates 13 in different pressure transducers is small, which makes consistency among respective pressure transducers better. For example, the thickness of the isolation plate 13 can be controlled by chemical mechanical polishing, so that thicknesses of the isolation plates 13 in different pressure transducers tends to be consistent.

A shape of an orthographic projection of the hollowed-out area of the isolation plate 13 on the first substrate 11 can be a polygon such as a square or a rectangle, a circle, or other irregular shapes, and schematic illustration is made only by taking the orthographic projection of the hollowed-out area on the first substrate 11 being the square as an example in the embodiment of the present disclosure.

Illustratively, along the direction perpendicular to the isolation plate 13, one side of the isolation plate 13 is sealingly connected to the first substrate 11, and the opposite other side of the isolation plate 13 is sealingly connected to the second substrate 12, so that the pressure reference chamber 10 is sealed.

With continued reference to FIG. 2, a first sealing ring 32 surrounding the pressure reference chamber 10 is arranged between the isolation plate 13 and the first substrate 11. One side of the first sealing ring 32 is sealingly connected to the first substrate 11, and the other side of the first sealing ring 32 is sealingly connected to the isolation plate 13, so that the isolation plate 13 and the first substrate 11 are sealingly connected to each other through the first sealing ring 32, to prevent external particles from entering the pressure reference chamber 10 along a joint between the isolation plate 13 and the first substrate 11.

The first sealing ring 32 may be a metal ring, in which case the isolation plate 13 and the first substrate 11 are connected and sealed by metal bonding.

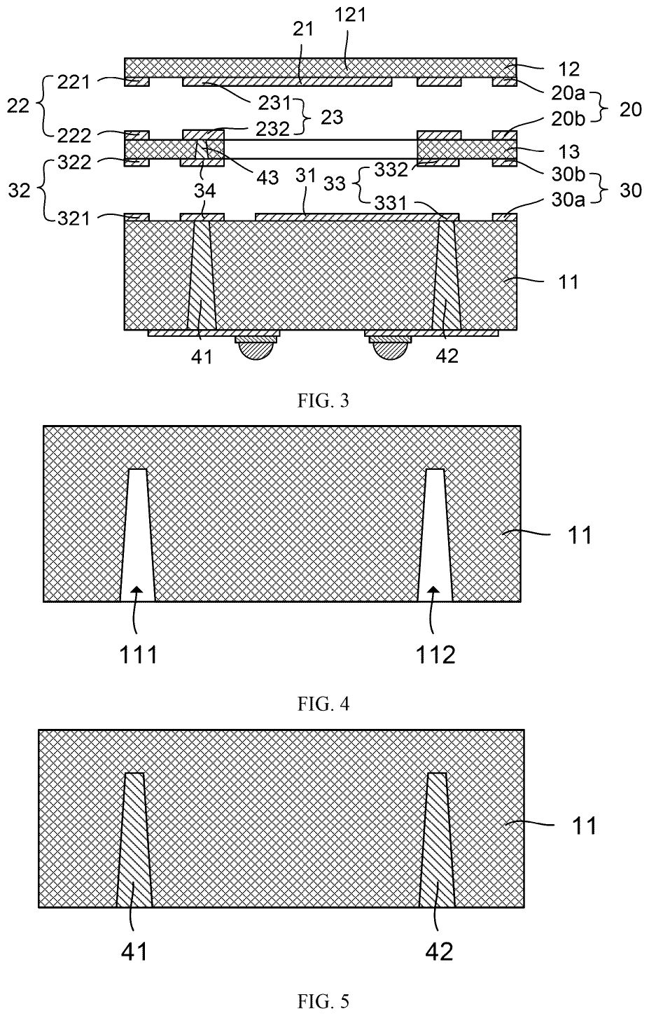

FIG. 3 is an exploded view of the pressure transducer shown in FIG. 2. Illustratively, as shown in FIG. 3, a first metal ring 321 surrounding the pressure reference chamber 10 is provided at a side of the first substrate 11 facing the isolation plate 13, and a second metal ring 322 surrounding the pressure reference chamber 10 is provided at a side of the isolation plate 13 facing the first substrate 11. The first metal ring 321 and the second metal ring 322 are oppositely arranged and are metal bonded to form the first sealing ring 32.

Certainly, the first sealing ring 32 can also be in a form of an adhesive, and the isolation plate 13 and the first substrate 11 can be adhered and sealed by the adhesive.

A second sealing ring 22 surrounding the pressure reference chamber 10 is arranged between the isolation plate 13 and the second substrate 12. One side of the second sealing ring 22 is sealingly connected to the second substrate 12, and the other side of the second sealing ring 22 is sealingly connected to the isolation plate 13, so that the isolation plate 13 and the second substrate 12 are sealingly connected to each other through the second sealing ring 22, to prevent external particles from entering the pressure reference chamber 10 along a joint between the isolation plate 13 and the second substrate 12.

The second sealing ring 22 may be a metal ring, in which case the isolation plate 13 and the second substrate 12 are connected and sealed by metal bonding.

Illustratively, with continued reference to FIG. 3, a third metal ring 221 surrounding the pressure reference chamber 10 is provided at a side of the second substrate 12 facing the isolation plate 13, and a fourth metal ring 222 surrounding the pressure reference chamber 10 is provided at a side of the isolation plate 13 facing the second substrate 12. The third metal ring 221 and the fourth metal ring 222 are arranged directly opposite to each other and are metal bonded to form the second sealing ring 22.

Certainly, the second sealing ring 22 can also be in a form of an adhesive, and the isolation plate 13 and the second substrate 12 can be adhered and sealed by the adhesive.

With continued reference to FIG. 3, a first metal layer 30 may be provided between the first substrate 11 and the isolation plate 13, and the first metal layer 30 includes the second polar plate 31 and the first sealing ring 32.

Illustratively, a first bonding layer 30a is provided at the side of the first substrate 11 facing the isolation plate 13, and a second bonding layer 30b is provided at the side of the isolation plate 13 facing the first substrate 11. The first bonding layer 30a and the second bonding layer 30b are made of a metal material (such as gold), and the first bonding layer 30a and the second bonding layer 30b are metal bonded to form the first metal layer 30. The first bonding layer 30a includes the first metal ring 321 and the second polar plate 31, and the second bonding layer 30b includes the second metal ring 322. The first metal ring 321 and the second metal ring 322 are oppositely arranged and are metal bonded to form the first sealing ring 32.

Both the second polar plate 31 and the first sealing ring 32 are located in the first metal layer 30, thus reducing a number of film layers of the pressure transducer and making the thickness of the pressure transducer smaller.

With continued reference to FIG. 3, a second metal layer 20 may be provided between the second substrate 12 and the isolation plate 13, and the second metal layer 20 includes the second polar plate 21 and the second sealing ring 22.

Illustratively, a third bonding layer 20a is provided at the side of the second substrate 12 facing the isolation plate 13, and a fourth bonding layer 20b is provided at the side of the isolation plate 13 facing the second substrate 12. The third bonding layer 20a and the fourth bonding layer 20b are made of a metal material (such as gold), and the third bonding layer 20a and the fourth bonding layer 20b are metal bonded to form the second metal layer 20. The third bonding layer 20a includes the third metal ring 221 and the first polar plate 21, and the fourth bonding layer 20b includes the fourth metal ring 222. The third metal ring 221 and the fourth metal ring 222 are oppositely arranged and are metal bonded to form the second sealing ring 22.

Both the first polar plate 21 and the second sealing ring 22 are located in the second metal layer 20, thus reducing a number of film layers of the pressure transducer and making the thickness of the pressure transducer smaller.

As shown in FIG. 3, the first metal layer 30 may further include a first lead-out member 33 located between the first substrate 11 and the isolation plate 13, one side of the first lead-out member 33 is connected to the first substrate 11, and the other side of the first lead-out member 33 is connected to the isolation plate 13.

Illustratively, the first bonding layer 30a includes a first lead-out structure 331, and the second bonding layer 30b includes a second lead-out structure 332. The first lead-out structure 331 and the second lead-out structure 332 are metal bonded to form the first lead-out member 33.

The second polar plate 31 is electrically connected to the first lead-out member 33, so that the second polar plate 31 can be electrically connected to an external detection circuit through the first lead-out member 33 outside the pressure reference chamber 10.

The first lead-out member 33 can be electrically connected to the first sealing ring 32 or disconnected from the first sealing ring 32.

As shown in FIG. 3, the second metal layer 20 may further include a second lead-out member 23 located between the second substrate 12 and the isolation plate 13, one side of the second lead-out member 23 is connected to the second substrate 12, and the other side of the second lead-out member 23 is connected to the isolation plate 13.

Illustratively, the third bonding layer 20a includes a third lead-out structure 231, and the fourth bonding layer 20b includes a fourth lead-out structure 232. The third lead-out structure 231 and the fourth lead-out structure 232 are metal bonded to form the second lead-out member 23.

The first polar plate 21 and the second lead-out member 23 are electrically connected to each other, so that the first polar plate 21 can be electrically connected to an external detection circuit through the second lead-out member 23 outside the pressure reference chamber 10, thereby preventing an electrical connection structure with the first polar plate 21 from affecting deformation of the pressure sensitive film 121.

The second lead-out member 23 can be electrically connected to the second sealing ring 22 or disconnected from the second sealing ring 22.

The second lead-out member 23 is located between the second substrate 12 and the isolation plate 13, rather than provided on the pressure sensitive film 121, and thus when the pressure sensitive film 121 is deformed, it may not drive the second lead-out member 23 to deform, and the second lead-out member 23 remains the same in shape. Similarly, the first lead-out member 33 is located between the first substrate 11 and the isolation plate 13, and also remains the same in shape. When orthogonal projections of the first lead-out member 33 and the second lead-out member 23 on the first substrate 11 overlap with each other, that is, the first lead-out member 33 is directly opposite to a part or all area of the second lead-out member 23, so that the first lead-out member 33 and the second lead-out member 23 form parasitic capacitance. The external detection circuit reads a total capacitance of the pressure transducer being equal to a sum of capacitance formed by the first plate 21 and the second plate 31 and the parasitic capacitance. When the capacitance formed by the first polar plate 21 and the second polar plate 31 changes, a ratio of change amount to the total capacitance decreases, which reduces detection accuracy of the change amount.

Therefore, the orthogonal projections of the first lead-out member 33 and the second lead-out member 23 on the first substrate 11 may not overlap with each other, so that parasitic capacitance is not easily formed between the first lead-out member 33 and the second lead-out member 23.

Referring to FIG. 2, the first metal layer 30 further includes an adapter 34 located between the isolation plate 13 and the first substrate 11, the adapter 34 is electrically connected to the second lead-out member 23 through a via, and the adapter 34 is disconnected from the second polar plate 31. The adapter 34 is electrically connected to the second lead-out member 23 through the via, and the second lead-out member 23 is electrically connected to the first polar plate 21, so that a signal of the first polar plate 21 can be output to the adapter 34, and the second polar plate 31 is electrically connected to the second lead-out member 23, so that a signal of the second polar plate 31 can be output to the second lead-out member 23. Since the second lead-out member 23 and the adapter 34 are both located in the first metal layer 30, signals of the pressure transducer can be output from a same side, which reduces difficulty in electrical connection between the pressure transducer and the external detection circuit.

Illustratively, the first metal layer 30 includes the adapter 34 and the second polar plate 31 which are disconnected from each other and the first sealing ring 32 surrounding the adapter 34 and the second polar plate 31, and the first sealing ring 32 is disconnected from the adapter 34 and the second polar plate 31.

Illustratively, as shown in FIG. 2, a third conductive pillar 43 is provided in the isolation plate 13, and the third conductive pillar 43 penetrates through the isolation plate 13 in a direction perpendicular to the isolation plate 13, one end of the third conductive pillar 43 is electrically connected to the second lead-out member 23, and the other end of the third conductive pillar 43 is electrically connected to the adapter 34.

With continued reference to FIG. 2, a first conductive pillar 41 can be provided in the first substrate 11, the first conductive pillar 41 penetrates through the first substrate 11 in a direction perpendicular to the first substrate 11. An end of the first conductive pillar 41 facing the second substrate 12 is electrically connected to the adapter 34, and the adapter 34 can be electrically connected to the second lead-out member 23 through the third conductive pillar 43, and the second lead-out member 23 is electrically connected to the first polar plate 21, thereby outputting a signal of the first polar plate 21 to an end of the first conductive pillar 41 away from the second substrate 12.

A second conductive pillar 42 may be provided in the first substrate 11, the second conductive pillar 42 penetrates through the first substrate 11 in the direction perpendicular to the first substrate 11. An end of the second conductive pillar 42 facing the second substrate 12 is electrically connected to the first lead-out member 33, and the first lead-out member 33 is electrically connected to the second polar plate 31, thereby outputting a signal of the second polar plate 31 to an end of the second conductive pillar 42 away from the second substrate 12.

On one hand, a signal of the capacitor is output to ends of the first conductive pillar 41 and the second conductive pillar 42 away from the second substrate 12, that is, the pressure transducer outputs the signals through the same side, which is more convenient for the electrical connection between the pressure transducer and the external detection circuit. For example, a Printed Circuit Board (PCB) is provided with a detection circuit. After the pressure transducer is connected to the PCB, a side of the first substrate 11 away from the second substrate 12 faces the PCB, so that the first conductive pillar 41 and the second conductive pillar 42 are electrically connected to the detection circuit.

On the other hand, when the silicon substrate is used in the related art, a lead-out line of a polar plate needs to extend in a direction parallel to the substrate, which increases a size of the pressure transducer in the direction parallel to the substrate. In the embodiment of the present disclosure, the signals of the first polar plate 21 and the second polar plate 31 are led out along the direction perpendicular to the first substrate 11 through the first conductive pillar 41 and the second conductive pillar 42, thereby reducing a size of the pressure transducer along a direction parallel to the first substrate 11. For example, when the first substrate 11 is the glass substrate, a via can be formed in the first substrate 11 by Through Glass Via (TGV) technology, and further the first conductive pillar 41 and the second conductive pillar 42 can be deposited in the via.

The first conductive pillar 41 and/or the second conductive pillar 42 may be electrically connected to the external detection circuit through a connector 50.

Illustratively, the connector 50 includes a redistribution layer 51 (abbreviated as RDL), an under bump metallization layer 52 (Under Ball Metal, abbreviated as UBM) and solder 53, which are sequentially arranged in the direction away from the first substrate 11. The redistribution layer 51 is electrically connected to a fourth conductive pillar 44 or a fifth conductive pillar 45, and the solder 53 is configured to be electrically connected to an external circuit after being melt. The under bump metallization layer 52 can prevent the solder 53 from climbing to the first substrate 11 and heating the first substrate 11 after being melt, and the under bump metallization layer 52 can prevent the solder 53 material from diffusing into the redistribution layer 51 and reduce adhesion between the redistribution layer 51 and the first substrate 11.

Illustratively, the connector 50 includes the redistribution layer 51 (abbreviated as RDL) and the under bump metallization layer 52 (Under Ball Metal, abbreviated as UBM) which are sequentially arranged in the direction away from the first substrate 11, and is electrically connected to the external detection circuit through the under bump metallization layer 52.

Illustratively, the connector 50 includes the under bump metallization layer 52 disposed on a side of the first substrate 11 away from the second substrate 12, and the under bump metallization layer 52 is directly electrically connected to the fourth conductive pillar 44 or the fifth conductive pillar 45, and is electrically connected to the external detection circuit through the under bump metallization layer 52.

In another embodiment of the present disclosure, as shown in FIG. 19, the pressure transducer includes a first substrate 11, a second substrate 12, a first polar plate 21 and a second polar plate 31. The second substrate 12 includes a pressure sensitive film 121, and the first substrate 11 includes a groove provided opposite to the pressure sensitive film 121 and a connecting part surrounding the groove, and the connecting part is connected to the second substrate 12.

Illustratively, the second substrate 12 is a glass substrate with a uniform thickness, and the side of the first substrate 11 away from the second substrate 12 is a plane, and a thickness of the first substrate 11 is larger at the connecting part and smaller at the groove. The second polar plate 31 is arranged on a bottom wall of the groove.

In order to reduce the dielectric loss and noise of the pressure transducer and be compatible with MEMS technology, the first substrate 11 can be a glass substrate. Certainly, the first substrate 11 may also be a silicon substrate.

The first substrate 11 is provided with the groove, so that the first substrate 11 and the second substrate 12 enclose the pressure reference chamber 10 at the groove. Compared with the above embodiment in which the first substrate 11, the isolation plate 13 and the second substrate 12 enclose the pressure reference chamber 10, a number of film layers is reduced in this embodiment, which makes a process of preparing the pressure transducer simpler and lower in cost.

Illustratively, the connecting part is sealingly connected to the second substrate 12, so that the pressure reference chamber 10 is sealed. Compared with the above embodiment in which one side of the isolation plate 13 is sealingly connected to the first substrate 11 and the other side of the isolation plate 13 is sealingly connected to the second substrate 12, only the first substrate 11 and the second substrate 12 are sealingly connected in this embodiment, which reduces positions requiring sealing connection and makes sealing of the pressure reference chamber 10 more reliable.

Referring to FIG. 19, a third sealing ring 61 is provided between the first substrate 11 and the second substrate 12. One side of the third sealing ring 61 is sealingly connected to the first substrate 11, and the opposite other side of the third sealing ring 61 is sealingly connected to the second substrate 12, so that the second substrate 12 and the first substrate 11 are sealingly connected to each other through the third sealing ring 61, to prevent external particles from entering the pressure reference chamber 10 along a joint between the second substrate 12 and the first substrate 11.

The third sealing ring 61 may be a metal ring, in which case the second substrate 12 and the first substrate 11 are connected and sealed by metal bonding.

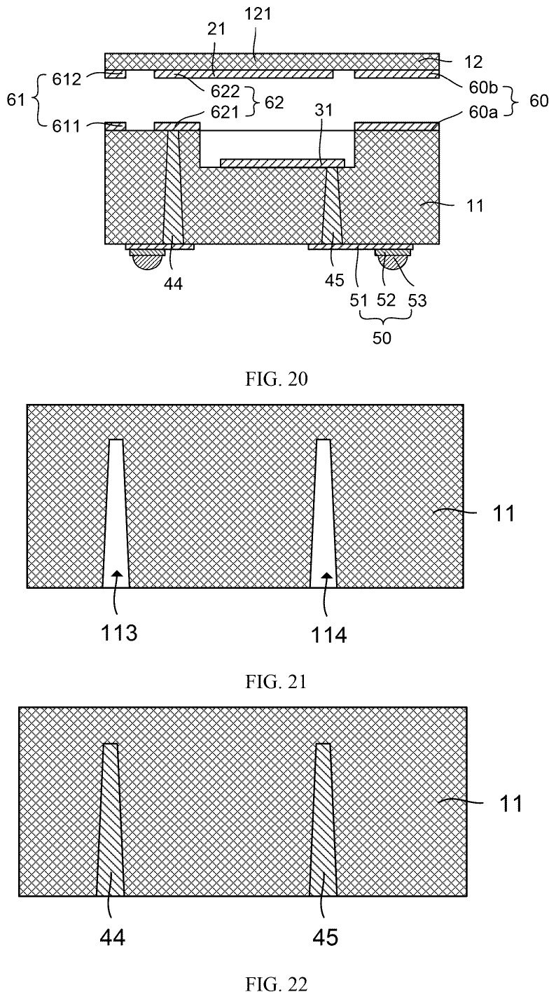

FIG. 20 is an exploded view of the pressure transducer shown in FIG. 19. Illustratively, as shown in FIG. 20, a fifth metal ring 611 surrounding the pressure reference chamber 10 is provided on a side of the connecting part of the first substrate 11 facing the second substrate 12, and a sixth metal ring 612 surrounding the pressure reference chamber 10 is provided on the side of the second substrate 12 facing the first substrate 11. The fifth metal ring 611 and the sixth metal ring 612 are arranged oppositely and are metal bonded to form the third sealing ring 61.

Certainly, the third sealing ring 61 can also be in a form of an adhesive, and the second substrate 12 and the first substrate 11 can be adhered and sealed by the adhesive.

As shown in FIG. 19, a third metal layer 60 is provided between the first substrate 11 and the second substrate 12, and the third metal layer 60 may include the first polar plate 21 and the third sealing ring 61.

Illustratively, as shown in FIG. 20, a fifth bonding layer 60a is provided at the side of the first substrate 11 facing the second substrate 12 and a sixth bonding layer 60b is provided at the side of the second substrate 12 facing the first substrate 11. The fifth bonding layer 60a and the sixth bonding layer 60b are made of a metal material (such as gold), and the fifth bonding layer 60a and the sixth bonding layer 60b are metal bonded to form the third metal layer 60. The sixth bonding layer 60b includes the sixth metal ring 612 and the first polar plate 21, and the fifth bonding layer 60a includes the fifth metal ring 611. The fifth metal ring 611 and the sixth metal ring 612 are oppositely arranged and are metal bonded to form the third sealing ring 61.

Both the first polar plate 21 and the third sealing ring 61 are located in the third metal layer 60, thus reducing a number of film layers of the pressure transducer and making the thickness of the pressure transducer smaller.

With continued reference to FIG. 20, the third metal layer 60 further includes a third lead-out member 62, the third lead-out member 62 is located between an edge area of the first substrate 11 and an edge area of the second substrate 12. One side of the third lead-out member 62 is connected to the second substrate 12 and the other side of the third lead-out member 62 is connected to the first substrate 11.

Illustratively, the fifth bonding layer 60a includes a fifth lead-out structure 621, and the sixth bonding layer 60b includes a sixth lead-out structure 622. The fifth lead-out structure 621 and the sixth lead-out structure 622 are metal bonded to form the third lead-out member 62.

The third lead-out member 62 is electrically connected to the first polar plate 21, so that the second polar plate 31 can be electrically connected to an external detection circuit through the third lead-out member 62 outside the pressure reference chamber 10.

The third lead-out member 62 can be electrically connected to the third sealing ring 61 or disconnected from the third sealing ring 61.

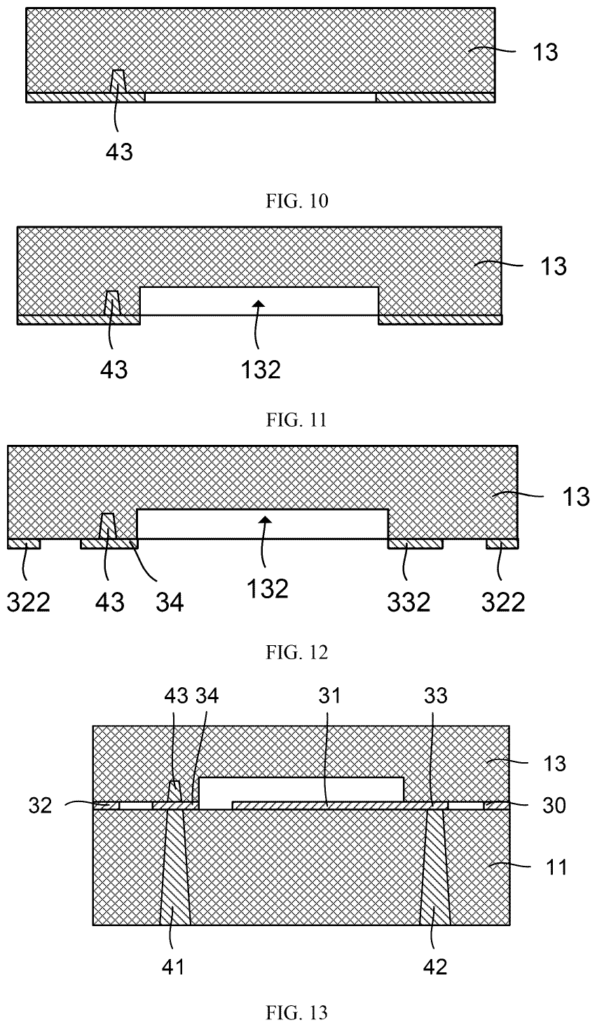

With continued reference to FIG. 10 and FIG. 20, the fourth conductive pillar 44 may be provided in the first substrate 11, the fourth conductive pillar 44 penetrates through the first substrate 11 in the direction perpendicular to the first substrate 11. An end of the fourth conductive pillar 44 facing the second substrate 12 is electrically connected to the third lead-out member 62, and the third lead-out member 62 is electrically connected to the first polar plate 21, thereby outputting a signal of the first polar plate 21 to an end of the fourth conductive pillar 44 away from the second substrate 12.

The fifth conductive pillar 45 may be further provided in the first substrate 11, the fifth conductive pillar 45 penetrates through the first substrate 11 in the direction perpendicular to the first substrate 11. An end of the fifth conductive pillar 45 facing the second substrate 12 is electrically connected to the second polar plate 31, thereby outputting a signal of the second polar plate 31 to an end of the fifth conductive pillar 45 away from the second substrate 12.

On one hand, a signal of the capacitor is output to ends of the fourth conductive pillar 44 and the fifth conductive pillar 45 away from the second substrate 12, that is, the pressure transducer outputs the signals through the same side, which is more convenient for the electrical connection between the pressure transducer and the external detection circuit. For example, a Printed Circuit Board (PCB) is provided with a detection circuit. After the pressure transducer is connected to the PCB, a side of the first substrate 11 away from the second substrate 12 faces the PCB, so that the fourth conductive pillar 44 and the fifth conductive pillar 45 are electrically connected to the detection circuit.

On the other hand, when the silicon substrate is used in the related art, a lead-out line of a polar plate needs to extend in a direction parallel to the substrate, which increases a size of the pressure transducer in the direction parallel to the substrate. In the embodiment of the present disclosure, the signals of the first polar plate 21 and the second polar plate 31 are led out along the direction perpendicular to the first substrate 11 through the fourth conductive pillar 44 and the fifth conductive pillar 45, thereby reducing a size of the pressure transducer along the direction parallel to the first substrate 11. For example, when the first substrate 11 is the glass substrate, a via can be formed in the first substrate 11 by Through Glass Via (TGV) technology, and further the fourth conductive pillar 44 and the fifth conductive pillar 45 can be deposited in the via.

The fourth conductive pillar 44 and/or the fifth conductive pillar 45 may be electrically connected to the external detection circuit through a connector 50.

Illustratively, the connector 50 includes a redistribution layer 51 (abbreviated as RDL), an under bump metallization layer 52 (Under Ball Metal, abbreviated as UBM) and solder 53, which are sequentially arranged in the direction away from the first substrate 11. The redistribution layer 51 is electrically connected to a fourth conductive pillar 44 or a fifth conductive pillar 45, and the solder 53 is configured to be electrically connected to an external circuit after being melt. The under bump metallization layer 52 can prevent the solder 53 from climbing to the first substrate 11 and heating the first substrate 11 after being melt, and the under bump metallization layer 52 can prevent the solder 53 material from diffusing into the redistribution layer 51 and reduce adhesion between the redistribution layer 51 and the first substrate 11.

Illustratively, the connector 50 includes the redistribution layer 51 (abbreviated as RDL) and the under bump metallization layer 52 (Under Ball Metal, abbreviated as UBM) which are sequentially arranged in the direction away from the first substrate 11, and is electrically connected to the external detection circuit through the under bump metallization layer 52.

Illustratively, the connector 50 includes the under bump metallization layer 52 disposed on a side of the first substrate 11 away from the second substrate 12, and the under bump metallization layer 52 is directly electrically connected to the fourth conductive pillar 44 or the fifth conductive pillar 45, and is electrically connected to the external detection circuit through the under bump metallization layer 52.

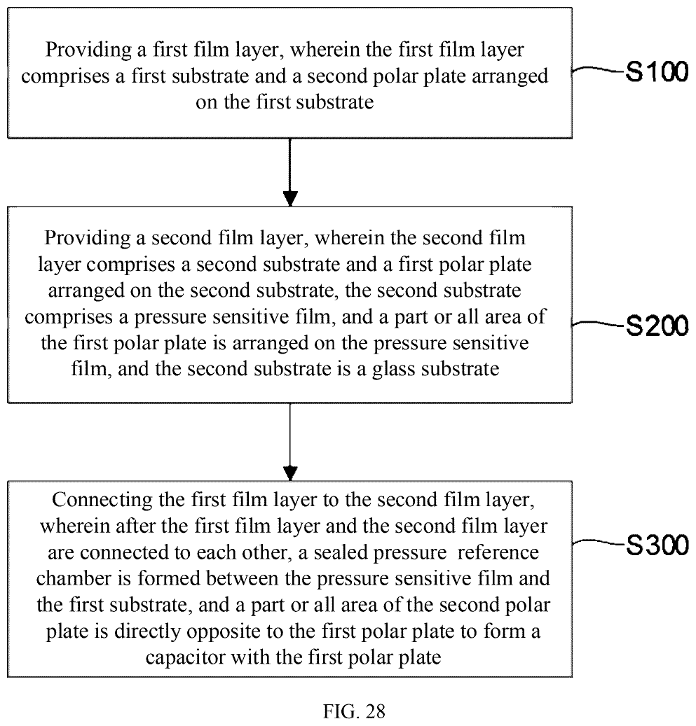

A preparation method of a pressure transducer is further provided in an embodiment of the present disclosure. FIG. 28 schematically shows a flowchart of a preparation method of a pressure transducer. As shown in FIG. 28, the preparation method of the pressure transducer includes following steps.

At S100, a first film layer is provided. The first film layer includes a first substrate and a second polar plate arranged on the first substrate.

At S200, a second film layer is provided. The second film layer includes a second substrate and a first polar plate arranged on the second substrate. The second substrate includes a pressure sensitive film, and a part or all area of the first polar plate is arranged on the pressure sensitive film. The second substrate is a glass substrate.

At S300, the first film layer is connected to the second film layer. After the first film layer and the second film layer are connected to each other, a sealed pressure reference chamber is formed between the pressure sensitive film and the first substrate, and a part or all area of the second polar plate is directly opposite to the first polar plate to form a capacitor with the first polar plate.

The second substrate is a glass substrate, that is, the second substrate is made of a glass material, and the pressure sensitive film is also made of the glass material as a part of the second substrate. Since an elastic modulus and Poisson's ratio of the glass material are smaller than those of the silicon material, it can be seen from a formula for calculating the maximum deformation that the pressure sensitive film made of the glass material can be thicker than that made of the silicon material in a case of ensuring a same maximum deformation, thus solving problems of easy breakage and high defect rate of the pressure sensitive film due to its small thickness. Moreover, the MEMS technology is compatible with the glass material, and when the second substrate is the glass substrate, the MEMS technology can be adopted to prepare the pressure transducer. Compared with the monolithic production mode of the ceramic-based capacitive pressure transducer, the pressure transducer according to the embodiment of the present disclosure can be prepared by the MEMES technology, which can improve production efficiency and consistency among different pressure transducers.

In some embodiments, the step S300 includes following steps.

At S310, an isolation plate is formed on the first film layer. The isolation plate is provided with a hollowed-out area.

At S320, the second film layer is connected on a side of the isolation plate away from the first film layer. The pressure sensitive film, the isolation plate and the first substrate enclose a pressure reference chamber in the hollowed-out area.

The isolation plate is located between the first substrate and the second substrate and

separates the first substrate and the second substrate. A thickness of the isolation plate (along a direction perpendicular to the isolation plate) directly affects a spacing between the first substrate and the second substrate. Since the first polar plate is arranged on the second substrate and the second polar plate is arranged on the first substrate, the gap between the first substrate and the second substrate directly affects the gap between the first polar plate and the second polar plate.

In preparing the pressure transducer, the gap between the first polar plate and the second polar plate can be controlled by controlling the thickness of the isolation plate, so that a distance error between the first polar plate and the second polar plate is smaller.

FIG. 4 to FIG. 18 schematically show a process flow chart of a pressure transducer.

Illustratively, as shown in FIG. 4 to FIG. 7, the step S100 includes following steps.

At S111, the first substrate is provided.

The first substrate 11 may be a glass substrate or a silicon substrate. In the following, only the first substrate 11 being a glass substrate is taken as an example.

At S112, a first blind hole and a second blind hole are formed in the first substrate.

Illustratively, positions in the first substrate 11 where the first blind hole 111 and the second blind hole 112 need to be defined are modified by laser induction to form a laser modified area. Then, the first blind hole 111 and the second blind hole 112 are etched in the laser modified area by wet etching, as shown in FIG. 4.

Illustratively, diameters of the first blind hole 111 and the second blind hole 112 are 10 μm to 1000 μm.

At S113, a first conductive pillar is formed in the first blind hole, and a second conductive pillar is formed in the second blind hole.

Illustratively, an adhesion layer and a plating layer are sequentially deposited on inner walls of the first blind hole 111 and the second blind hole 112 by using a Physical Vapor Deposition (PVD) or Chemical Vapor Deposition (CVD) process. The adhesion layer can be made of titanium or chromium with a thickness of 20 nm to 50 nm, and the plating layer can be made of copper, and the plating layer can fill up the first blind hole 111 and the second blind hole 112, as shown in FIG. 5.

At S114, two sides of the first substrate are thinned.

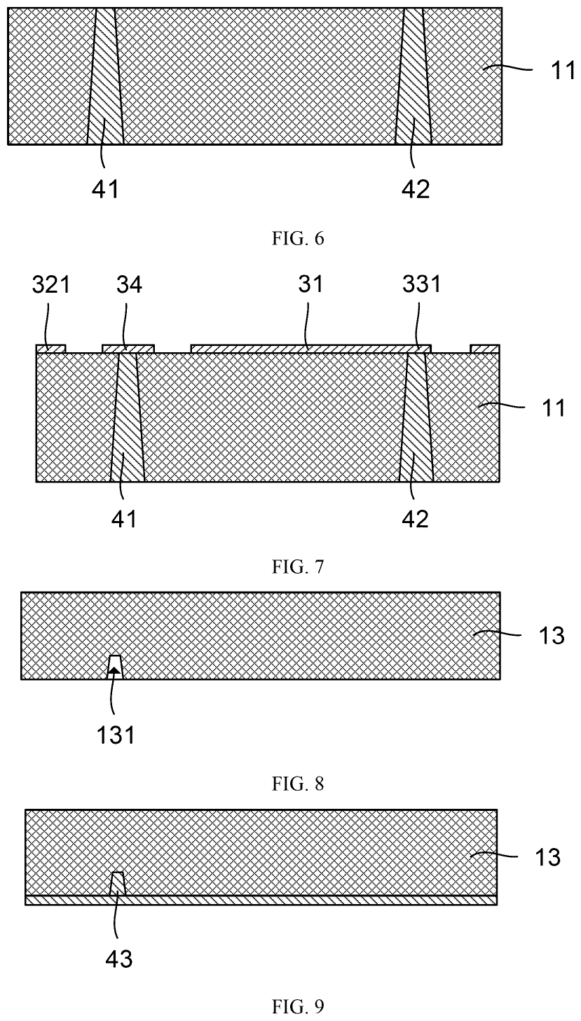

The two sides of the first substrate 11 refer to two sides in a direction perpendicular to the first substrate 11. After the first substrate 11 is thinned, the first conductive pillar 41 and the second conductive pillar 42 penetrate through the first substrate 11 in the direction perpendicular to the first substrate 11. The thinning can be made by chemical mechanical polishing or etching. After the thinning, a structure shown in FIG. 6 is formed.

At S115, a first bonding layer is provided on a side of the first substrate.

Illustratively, as shown in FIG. 7, the first bonding layer includes a second polar plate 31, a first lead-out structure 331, an adapter 34 and a first metal ring 321 surrounding the second polar plate 31, the adapter 34 and the first lead-out structure 331. The first lead-out structure 331 is electrically connected to the second pole plate 31, and the second pole plate 31 is electrically connected to the second conductive pillar 42. The first metal ring 321 is disconnected from the first lead-out structure 331 and the second polar plate 31, and the adapter 34 is disconnected from the second polar plate 31.

Illustratively, as shown in FIG. 8 to FIG. 15, the step S310 includes following steps.

At S311, an isolation plate is provided.

The isolation plate 13 may be a glass substrate or a silicon substrate, and in the following, only the isolation plate being the glass substrate is taken as an example.

At S312, a third blind hole is formed on a side of the isolation plate.

Illustratively, positions in the isolation plate 13 where the third blind hole 131 needs to be defined are modified by laser induction to form a laser modified area. Then, the third blind hole 131 is etched in the laser modified area by wet etching, as shown in FIG. 8.

Illustratively, a diameter of the third blind hole 131 is 10 μm to 1000 μm.

At S313, a third conductive pillar is formed in the third blind hole.

Illustratively, an adhesion layer and a plating layer are sequentially deposited on an inner wall of the third blind hole 131 by using a Physical Vapor Deposition (PVD) or Chemical Vapor Deposition (CVD) process. The adhesion layer can be made of titanium or chromium with a thickness of 20 nm to 50 nm, and the plating layer can be made of copper, and the plating layer can fill up the third blind hole 131, as shown in FIG. 9.

At S314, a hollowed-out area is formed on the isolation plate.

Illustratively, firstly, a metal layer covering the isolation plate is etched to expose a part of the isolation plate (as shown in FIG. 10), and then the part of the isolation plate 13 is hollowed out by etching to form the hollowed-out region 132, as shown in FIG. 11.

At S315, a second bonding layer is formed on a side of the isolation plate provided with the third blind hole.

Illustratively, the second bonding layer includes a second metal ring 322, a second lead-out structure 332, and an adapter 34. The adapter 34 is electrically connected to the third conductive pillar 43.

At S316, the isolation plate is connected to the first substrate.

Illustratively, as shown in FIG. 13, the first bonding layer 30a and the second bonding layer 30b are metal bonded to form a first metal layer 30 to connect the first substrate 11 and the isolation plate 13. When the first bonding layer 30a and the second bonding layer 30b are bonded, the first metal ring 321 and the second metal ring 322 are bonded to form a first sealing ring 32, and the first lead-out structure 331 and the second lead-out structure 332 are bonded to form a first lead-out member 33.

At S317, a side of the isolation plate away from the first substrate is thinned.

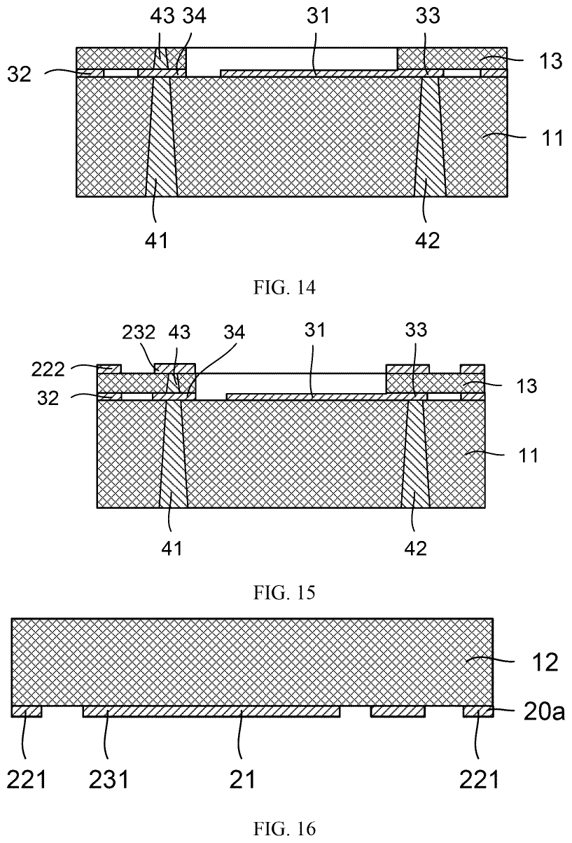

The thinning can be made by chemical mechanical polishing or etching. After the thinning, a structure shown in FIG. 14 is obtained.

At S318, a fourth bonding layer is formed on a side of the isolation plate away from the first substrate.

Illustratively, as shown in FIG. 15, the fourth bonding layer includes a fourth metal ring 222 and a fourth lead-out structure 232.

Illustratively, as shown in FIG. 16 to FIG. 18, the step S320 includes following steps.

At S321, a second substrate is provided.

The second substrate 12 is a glass substrate.

At S322, a third bonding layer is formed on a side of the second substrate.

Illustratively, as shown in FIG. 16, the third bonding layer 20a includes a third metal ring 221, a third lead-out structure 231, and a first polar plate 21.

At S323, the second substrate is connected to the isolation plate.

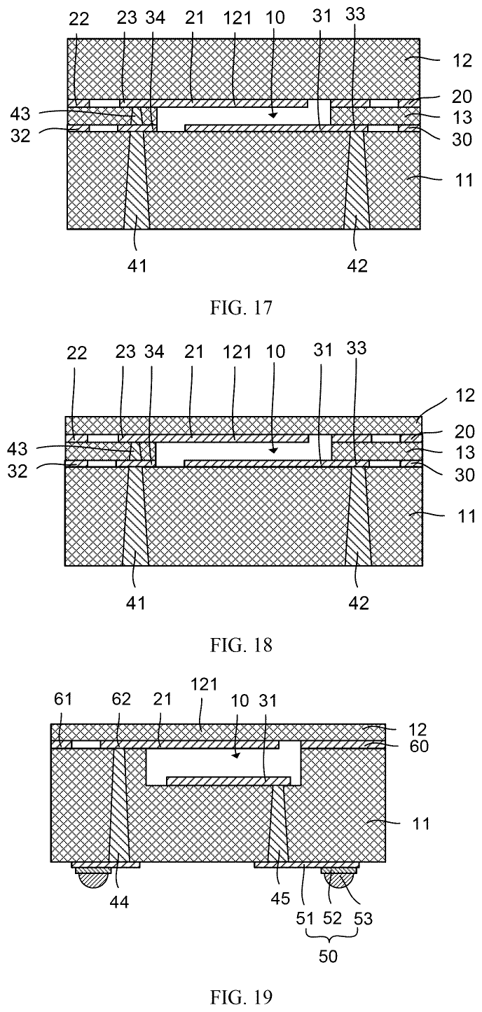

Illustratively, the third bonding layer and the fourth bonding layer are metal bonded to form a second metal layer 20 to connect the second substrate 12 and the isolation plate 13, so that the isolation plate 13 and the second substrate 12 are sealingly connected to each other, as shown in FIG. 17.

At S324, a side of the second substrate away from the first substrate is thinned.

After the thinning, a structure shown in FIG. 18 is obtained. The thinning can be made by chemical mechanical polishing or etching.

In some embodiments, the preparation method of the pressure transducer may further include a step S400.

At S400, a connector is formed on a side of the first substrate far from the second substrate.

The connector 50 is configured to be electrically connected to an external detection circuit.

Illustratively, the connector 50 includes a redistribution layer 51, an under bump metallization layer 52 and solder 53, which are sequentially arranged in the direction away from the first substrate 11. The redistribution layer 51 is electrically connected to a fourth conductive pillar 44 or a fifth conductive pillar 45, and the solder 53 is configured to be electrically connected to an external circuit after being melt. The under bump metallization layer 52 can prevent the solder 53 from climbing to the first substrate 11 and heating the first substrate 11 after being melt, and the under bump metallization layer 52 can prevent the solder 53 material from diffusing into the redistribution layer 51 and reduce adhesion between the redistribution layer 51 and the first substrate 11.

Illustratively, an adhesion layer and a plating layer are sequentially deposited on the first substrate 11 by a PVD or CVD process. The adhesion layer is made of titanium or chromium with a thickness of 20 nm to 50 nm, and the plating layer is made of copper with a thickness of 0.2 μm to 0.5 μm. After plating, photolithography is performed to form the redistribution layer 51.

Illustratively, the under bump metallization layer 52 is deposited by PVD or plating. The under bump metallization layer 52 can be made of an indium material or an alloy material such as a copper-tin alloy, with a thickness of 2 μm to 15 μm.

Illustratively, the solder 53 is a solder ball. Metal solder paste is brushed on the side of the first substrate 11 away from the second substrate 12 by screen printing, and then preparation of the solder ball is completed by thermal refluxing.

In some embodiments, the first substrate includes a groove and a connecting part surrounding the groove, and the step S300 in which the first film layer is connected to the second film layer includes a following step.

At S330, the second substrate is sealingly connected to the connecting part of the first substrate. After the second substrate is connected to the first substrate, the pressure sensitive film and the groove enclose a pressure reference chamber.

The first substrate is provided with the groove, so that the first substrate and the second substrate enclose the pressure reference chamber at the groove. Compared with the pressure reference chamber enclosed by the first substrate, the isolation plate and the second substrate, a number of film layers is reduced after the first substrate is provided with the groove, which makes a process of preparing the pressure transducer simpler and lower in cost.

FIG. 21 to FIG. 27 schematically show a process flow chart of another pressure transducer. As shown in FIG. 21 to FIG. 27, the preparation method of the pressure transducer includes following steps.

Illustratively, as shown in FIG. 21 to FIG. 24, the step S100 includes following steps.

At S121, the first substrate is provided.

The first substrate 11 may be a glass substrate or a silicon substrate, and in the following, only the first substrate 11 being the glass substrate is taken as an example.

At S122, a fourth blind hole and a fifth blind hole are formed in the first substrate.

Illustratively, positions in the first substrate 11 where the fourth blind hole 113 and the fifth blind hole 114 need to be defined are modified by laser induction to form a laser modified area. Then, the fourth blind hole 113 and the fifth blind hole 114 are etched in the laser modified area by wet etching, as shown in FIG. 21.

Illustratively, diameters of the fourth blind hole 113 and the fifth blind hole 114 are 10 μm to 1000 μm.

At S123, a fourth conductive pillar and a fifth conductive pillar are formed in the fourth blind hole and the fifth blind hole.

Illustratively, an adhesion layer and a plating layer are sequentially deposited on inner walls of the fourth blind hole 113 and the fifth blind hole 114 by using a Physical Vapor Deposition (PVD) or Chemical Vapor Deposition (CVD) process. The adhesion layer can be made of titanium or chromium with a thickness of 20 nm to 50 nm, and the plating layer can be made of copper, and the plating layer can fill up the fourth blind hole 113 and the fifth blind hole 114, as shown in FIG. 22.

At S124, a groove is formed on a side of the first substrate, and two sides of the first substrate are thinned.

The one side of the first substrate 11 refers to a side in a direction perpendicular to the first substrate 11. After the groove 115 is formed on the first substrate 11, a connecting part surrounding the groove 115 is also formed. The fourth conductive pillar 44 is located at the connecting part, and an end of the fifth conductive pillar 45 is flush with a bottom wall of the groove 115.

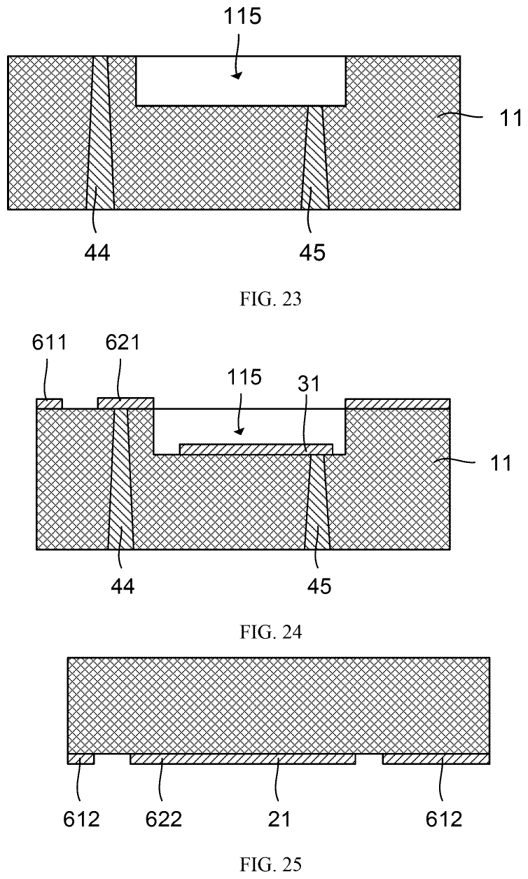

The thinning can be made by chemical mechanical polishing or etching. After the thinning, a structure shown in FIG. 23 is formed.

At S125, a fifth bonding layer is provided on a side of the first substrate where the groove is provided.

Illustratively, as shown in FIG. 24, the fifth bonding layer includes a fifth metal ring 611 and a fifth lead-out structure 621 located at the connecting part, and the fifth lead-out structure 621 is electrically connected to an end of the fourth conductive pillar 44. The fifth metal ring 611 and the fifth lead-out structure 621 can be arranged to be disconnected from each other. The fifth bonding layer further includes a second polar plate 31 located at the bottom wall of the groove. Illustratively, as shown in FIG. 25, the step S200 includes following steps.

At S221, the second substrate is provided.

The second substrate 12 is a glass substrate.

At S222, a sixth bonding layer is formed on a side of the second substrate.

Illustratively, the sixth bonding layer includes a sixth metal ring 612, a sixth lead-out structure 622, and a first polar plate 21. The sixth lead-out structure 622 is electrically connected to the first polar plate 21. The sixth metal ring 612 may be disconnected from the sixth lead-out structure 622, as shown in FIG. 25.

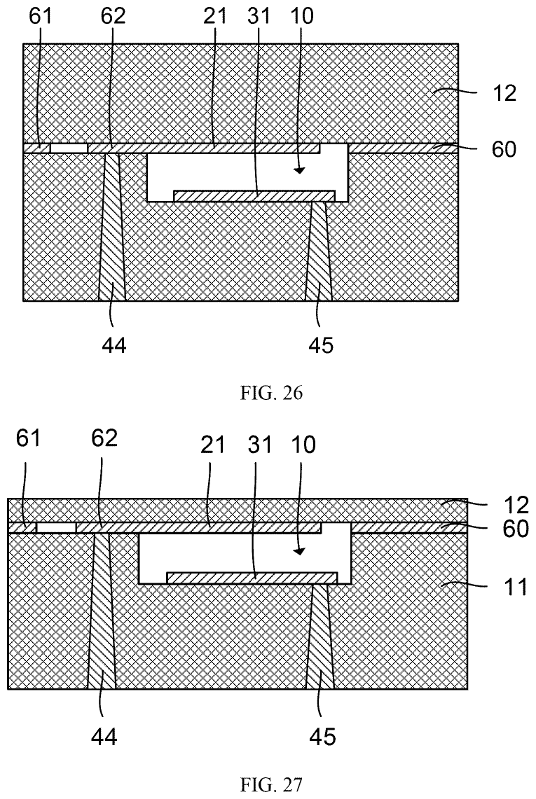

Illustratively, as shown in FIG. 26 and FIG. 27, the step S300 includes following steps.

At S331, the first substrate is connected to the second substrate.

Illustratively, the fifth bonding layer and the sixth bonding layer are metal bonded to form a third metal layer 60, so that the first substrate 11 and the second substrate 12 are sealingly connected to each other, and a structure shown in FIG. 26 is obtained.

At S332, a side of the second substrate away from the first substrate is thinned.

The thinning can be made by chemical mechanical polishing or etching. After the thinning, a structure shown in FIG. 27 is obtained.

In some embodiments, the preparation method of the pressure transducer may further include a step S400.

At S400, a connector is formed on a side of the first substrate far from the second substrate.

The connector 50 is configured to be electrically connected to an external detection circuit.

Illustratively, the connector 50 includes a redistribution layer 51, an under bump metallization layer 52 and solder 53, which are sequentially arranged in the direction away from the first substrate 11. The redistribution layer 51 is electrically connected to a fourth conductive pillar 44 or a fifth conductive pillar 45, and the solder 53 is configured to be electrically connected to an external circuit after being melt. The under bump metallization layer 52 can prevent the solder 53 from climbing to the first substrate 11 and heating the first substrate 11 after being melt, and the under bump metallization layer 52 can prevent the solder 53 material from diffusing into the redistribution layer 51 and reduce adhesion between the redistribution layer 51 and the first substrate 11.

Illustratively, an adhesion layer and a plating layer are sequentially deposited on the first substrate 11 by a PVD or CVD process. The adhesion layer is made of titanium or chromium with a thickness of 20 nm to 50 nm, and the plating layer is made of copper with a thickness of 0.2 μm to 0.5 μm. After plating, photolithography is performed to form the redistribution layer 51.

Illustratively, the under bump metallization layer 52 is deposited by PVD or plating. The under bump metallization layer 52 can be made of an indium material or an alloy material such as a copper-tin alloy, with a thickness of 2 μm to 15 μm.

Illustratively, the solder 53 is a solder ball. Metal solder paste is brushed on the side of the first substrate 11 away from the second substrate 12 by screen printing, and then preparation of the solder ball is completed by thermal refluxing.

A detection device for detecting a pressure of external gas or liquid is further provided in an embodiment of the present disclosure. The detection device includes a control panel and the pressure transducer described above. A detection circuit is provided on the control panel, and the pressure transducer is electrically connected to the detection circuit.

Illustratively, the control board is a PCB board with a detection circuit provided thereon, and the pressure transducer is connected to the PCB board and electrically connected to the detection circuit.

The above is only a specific implementation of the present disclosure, but the scope of protection of the present disclosure is not limited to this. Any person skilled in the art can easily think of changes or replacements within the technical scope disclosed in the present disclosure, which should be included in the scope of protection of the present disclosure. Therefore, the scope of protection of the present disclosure should be based on the scope of protection of the claims.

The above described embodiments of the device are only illustrative, where the units described as separate components may or may not be physically separated, and the components displayed as units may or may not be physical units, that is, they can be located in one place or distributed across multiple network units. Some or all of the modules can be selected according to actual needs to achieve the purpose of this embodiment. Persons skilled in the art can understand and implement without putting in creative effort.

The term “one embodiment”, “embodiment” or “one or more embodiments” referred to in this specification means that specific features, structures or characteristics described in conjunction with the embodiments are included in at least one embodiment disclosed herein. Furthermore, please note that the word “in one embodiment” may not necessarily refer to the same embodiment.

In the specification provided here, a large number of specific details are explained. However, it can be understood that the disclosed embodiments can be practiced without these specific details. In some examples, well-known methods, structures, and techniques are not shown in detail to avoid blurring the understanding of this specification.

In the claims, any reference symbols located between parentheses should not be constructed as limitations on the claims. The word “comprising” does not exclude the existence of elements or steps that are not listed in the claims. The word “a/an” or “one” before the component does not exclude the existence of multiple such components. The present disclosure can be implemented by means of hardware including several different components and by means of appropriately programmed computers. In the unit claims listing several devices, several of these devices may be specifically embodied through the same hardware item. The use of words such as first, second, and third does not indicate any order. These words can be interpreted as names.

Finally, it should be noted that the above embodiments are only used to illustrate the disclosed technical solution and not to limit it. Although the present disclosure has been described in detail with reference to the aforementioned embodiments, those skilled in the art should understand that they can still modify the technical solutions described in the aforementioned embodiments, or equivalently replace some of the technical features. And these modifications or substitutions do not depart from the essence and scope of the corresponding technical solutions disclosed in the present disclosure.

1. A pressure transducer, comprising:
a first substrate;
a second substrate comprising a pressure sensitive film, wherein a sealed pressure reference chamber is provided between the pressure sensitive film and the first substrate, the pressure sensitive film is capable to be deformed in a direction towards or away from the first substrate, and the second substrate is a glass substrate;
a first polar plate, wherein a part or all area of the first polar plate is arranged on the pressure sensitive film; and
a second polar plate arranged on a side of the first substrate facing the pressure sensitive film, wherein a part or all area of the second polar plate is directly opposite to the first polar plate to form a capacitor with the first polar plate.

2. The pressure transducer according to claim 1, wherein an isolation plate is provided between the first substrate and the second substrate, and an area on the isolation plate opposite to the pressure sensitive film is hollowed out, so that the first substrate, the second substrate and the isolation plate enclose the pressure reference chamber in a hollowed-out area.

3. The pressure transducer according to claim 2, wherein a first sealing ring surrounding the pressure reference chamber is provided between the isolation plate and the first substrate; and/or,
a second sealing ring surrounding the pressure reference chamber is provided between the isolation plate and the second substrate.

4. The pressure transducer according to claim 3, wherein the first sealing ring and/or the second sealing ring are metal rings.

5. The pressure transducer according to claim 4, wherein a first metal layer is provided between the first substrate and the isolation plate, and the first metal layer comprises the second polar plate and the first sealing ring; and/or,
a second metal layer is provided between the second substrate and the isolation plate, and the second metal layer comprises the first polar plate and the second sealing ring.

6. The pressure transducer according to claim 5, wherein the first metal layer further comprises a first lead-out member located between the first substrate and the isolation plate, and the second polar plate is electrically connected to the first lead-out member; and/or,
the second metal layer further comprises a second lead-out member located between the second substrate and the isolation plate, and the first polar plate is electrically connected to the second lead-out member.

7. The pressure transducer according to claim 6, wherein orthogonal projections of the first lead-out member and the second lead-out member on the first substrate do not overlap with each other.

8. The pressure transducer according to claim 6, wherein the first metal layer further comprises an adapter located between the isolation plate and the first substrate, the adapter is electrically connected to the second lead-out member through a via, and the adapter is disconnected from the second polar plate.

9. The pressure transducer according to claim 8, wherein a first conductive pillar and a second conductive pillar are provided in the first substrate, the first conductive pillar and the second conductive pillar penetrate through the first substrate in a direction perpendicular to the first substrate, an end of the first conductive pillar facing the second substrate is electrically connected to the adapter, and an end of the second conductive pillar facing the second substrate is electrically connected to the first lead-out member.

10. The pressure transducer according to claim 1, wherein the first substrate comprises a groove arranged opposite to the pressure sensitive film and a connecting part surrounding the groove, and the connecting part is connected to the second substrate.

11. The pressure transducer according to claim 10, wherein a third metal layer is provided between the first substrate and the second substrate, and the third metal layer comprises the first polar plate and a third sealing ring, and the first substrate and the second substrate are sealingly connected to each other through the third sealing ring.

12. The pressure transducer according to claim 11, wherein the third metal layer further comprises a third lead-out member located between an edge area of the first substrate and an edge area of the second substrate, and the third lead-out member is electrically connected to the first polar plate; and
a fourth conductive pillar and a fifth conductive pillar are provided in the first substrate, the fourth conductive pillar and the fifth conductive pillar penetrate through the first substrate along a direction perpendicular to the first substrate, an end of the fourth conductive pillar facing the second substrate is electrically connected to the third lead-out member, and an end of the fifth conductive pillar facing the second substrate is electrically connected to the second polar plate.

13. The pressure transducer according to claim 1, wherein the first substrate is the glass substrate.

14. The pressure transducer according to claim 2, wherein the isolation plate is the glass substrate.

15. The pressure transducer according to claim 1, wherein a side of the first substrate away from the second substrate is provided with a connector, the connector is electrically connected to the first plate or the second plate, and the connector is configured to be electrically connected to an external detection circuit; and
the connector comprises a redistribution layer, an under bump metallization layer and solder which are sequentially arranged along a direction away from the first substrate.

16. The pressure transducer according to claim 1, wherein the second substrate and the first substrate are oppositely arranged, and the second substrate comprises a middle area in the middle and an edge area surrounding the middle area, the edge area of the second substrate is sealingly connected to the first substrate, so that the middle area of the second substrate and the first substrate enclose a sealed pressure reference chamber, and the pressure sensitive film is located in the middle area of the second substrate.

17. The pressure transducer according to claim 16, wherein a second groove is provided on a side of the middle area of the second substrate facing the first substrate, and the second groove and the first substrate enclose the pressure reference chamber.

18. The pressure transducer according to claim 16, wherein a first groove is provided in an area of the first substrate opposite to the middle area, and the first groove and the second substrate enclose the pressure reference chamber.

19. The pressure transducer according to claim 16, wherein a first groove is provided in an area of the first substrate opposite to the middle area, and a second groove is provided on a side of the middle area of the second substrate facing the first substrate, and the first groove and the second groove are buckled to form the pressure reference chamber.

20-22. (canceled)

23. A detection device, comprising a control panel and the pressure transducer according to claim 1, wherein a detection circuit is provided on the control panel, and the pressure transducer is electrically connected to the detection circuit.
